(19) United States
(12) Patent Application Publication
(10) Pub. No.: US 2004/0069923 A1
(43) Pub. Date: Apr. 15, 2004

(54) Base support for a flag

(76) Inventor: Greg Steenbock, Ida Grove, IA (US)

Correspondence Address: Davis, Brown, Koehn, Shors & Roberts, P.C., The Financial Center, Suite 2500, 666 Walnut Street, Des Moines, IA, 50309-3993, US

(21) Appl. No.: 10/271,396

(22) Filed: Oct. 15, 2002

(51) Int. Cl. H01Q 1/12

(52) U.S. Cl. 248/538

(57) ABSTRACT

A flag support block for use in the stationary display of flags sold for mounting on the windows of vehicles. The flag support block includes a base member and a projected lip member. The flag support block can be used to display flags in either a horizontal or a vertical orientation. In the horizontal orientation, the flags are displayed in a manner similar to that when used for their intended purpose on a vehicle window. Alternatively, the flag support block may be mounted on a vertical surface whereupon the flag is pivoted 180° relative to the projected lip member to position the flag at a suitable display angle.

### BACKGROUND OF THE INVENTION

The present invention relates, generally, to a base support for a flag of the type that is sold for display mounted on the free edge of an automobile window and, more specifically, to a base support for a flag staff which supports a flag for display on a horizontal surface when used in a first orientation and on a vertical surface when used in a second, pivoted orientation.

In recent years, providers of sports memorabilia have started to sell flags that display an emblem, insignia, logo, or other design of a sports team. The flags are sold on a staff which has a mounting apparatus suitable for support on the free edge of an automobile window. The support and associated flag staff and flag are securely held on the window when the window is returned to its rolled-up position, trapping the support between the window and the door frame. The flags are displayed outside of the vehicle and are most commonly attached when traveling to and from a sporting event involving the team whose insignia is displayed on the flag.

Many sports enthusiasts, however, have an interest in displaying the flags in a stationary position, such as in a home or office environment. In particular, sports memorabilia collectors accumulate and want to preserve and display a wide variety of flags, and often never use such flags on vehicles because of the damage that may occur to the flags under the harsh conditions of being exposed to the elements and travel at high speeds. Accordingly, there is a need for a flag support base which will allow the display of these flags in a stationary position.

### SUMMARY OF THE INVENTION

The invention consists of a support block for flags sold to be mounted to vehicle windows. The support block comprises a base element from which projects at an angle a supporting lip member. With the base member mounted on a horizontal surface, the lip member projects at an angle which approximates that of a vehicle window. The flag is attached to the lip member in the same way as it is attached to the free edge of a vehicle window. Alternatively, the base member may be mounted on a vertical surface whereupon the flag is again supported on the lip member but has been pivoted 180°. Accordingly, the support block of the present invention is suitable for use in displaying such flags in either the horizontal or vertical orientation, that is, for example, either for display on a table, desk, or the like, or on a wall.

An object of the present invention is to provide a flag support block to display a flag on various surfaces.

It is a further object of the invention to provide a support block for displaying flags designed for mounting on vehicle windows to display the flags in a stationary position either supported on a horizontal surface or on a vertical surface.

These and other objects of the invention will become more apparent from a review and understanding of this specification, the accompanying drawings and the appended claims.

The drawings illustrate preferred embodiments of the present invention. It should be understood, however, that the drawings are merely illustrative and are not intended to limit the full scope of the present invention.

### BRIEF DESCRIPTION OF THE DRAWINGS

FIG. 1 is a perspective view of a flag support block of the present invention in a horizontal position and showing its use to display a flag manufactured for mounting on a vehicle window.

FIG. 2 is a side view of the support block of FIG. 1.

FIG. 3 is a front view of the support block of FIG. 1.

FIG. 4 is a perspective view of the support block of the present invention shown in a vertical orientation and supporting a flag intended for display on a vehicle window.

FIG. 5 is a side view of the support block of FIG. 4.

FIG. 6 is a front view of the support block of FIG. 4.

### DETAILED DESCRIPTION OF A PREFERRED EMBODIMENT

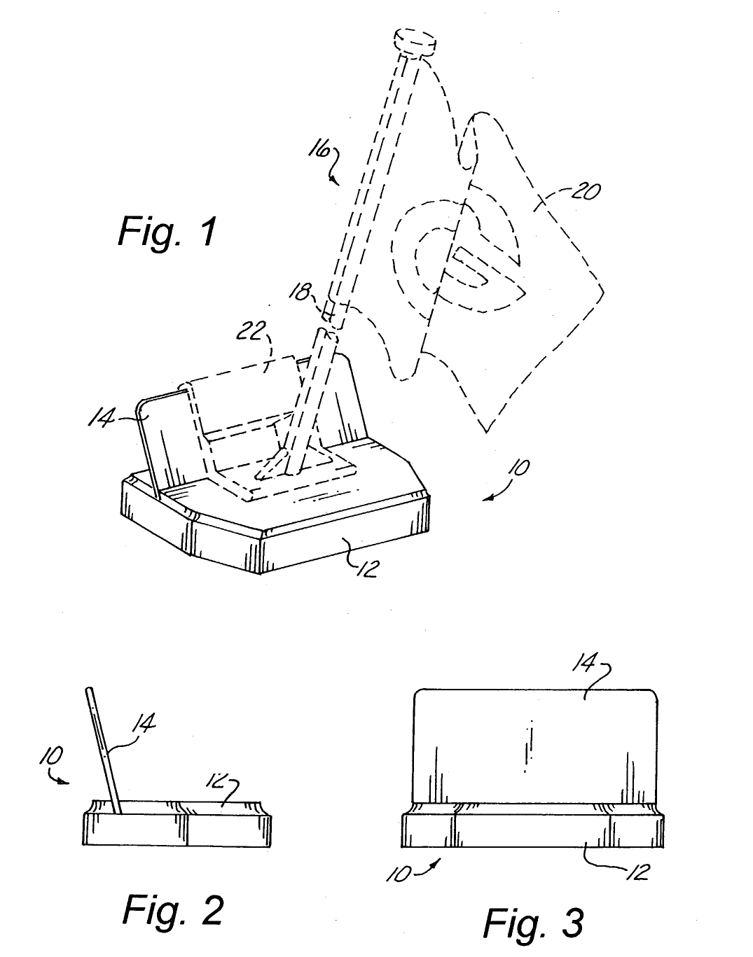

Referring to FIG. 1 there is illustrated, generally at 10, a flag support block of the present invention. The flag support block 10 includes a base member 12 and a projecting lip member 14. As best illustrated in FIG. 2, when the flag support block 10 is used in the horizontal position, as illustrated in FIG. 1, the lip member 14 projects upwardly at an angle away from the vertical relative to the base member 12.

A typical display flag sold for mounting on a vehicle window is illustrated generally at 16 in FIG. 1. Included in the display flag 16 is a flagstaff 18, a flag 20, and a mounting member 22. The mounting member 22 is substantially U-shaped in cross section, being originally intended for mounting on the free edge portion of a vehicle window. When used with the flag support block 10 of the present invention, the lip member 14 is received inside the U-shaped mounting member 22, as illustrated in FIG. 1. Since the angle of the lip member 14 approximates that of a vehicle window, the display flag 16 is displayed in an orientation that is close to that of its intended orientation when mounted to a vehicle window.

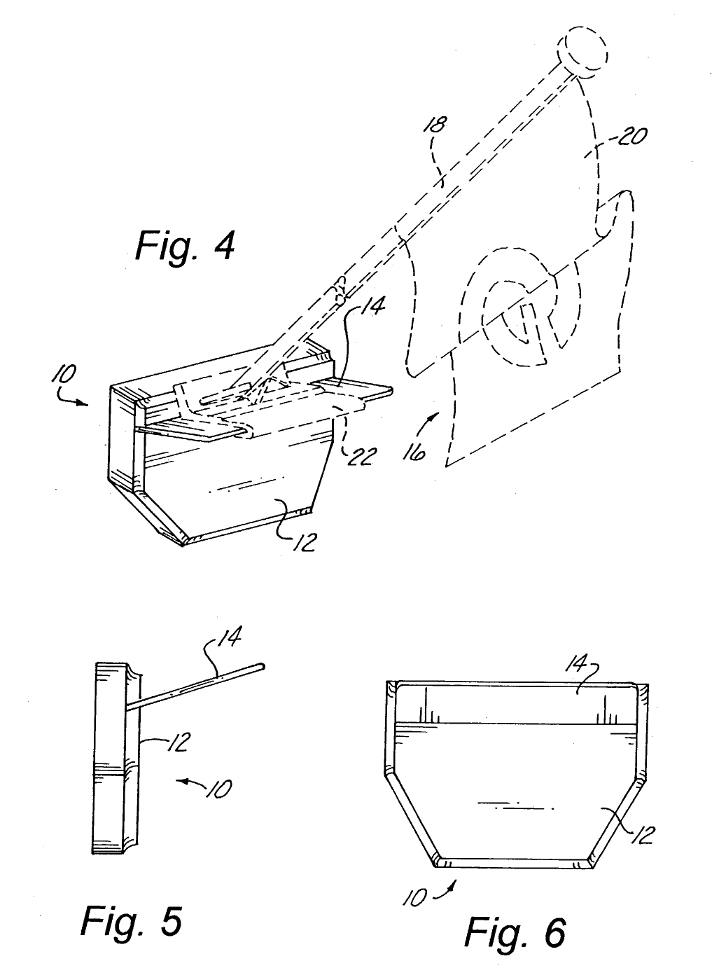

Alternatively, the flag support block 10 can be positioned in a vertical orientation, as illustrated in FIG. 4. In this orientation, the mounting member 22 of the flag 16 has been pivoted through an angle of 180° relative to the lip member 14 so that the flag 16 is again retained on the flag support block 10 and positioned in an orientation suitable for display. Since the flag 20 is mounted on a sleeve that is free to rotate about the flag staff 18, it automatically pivots or rotates to the appropriate position. Side and front views of the flag support block 10 in the vertical orientation are illustrated in FIGS. 5 and 6, respectively.

The flag support block 10 may be manufactured of any suitable material such as wood, metal, plastic, or the like. While in the preferred embodiment, it has been recited that the lip member 14 be in the approximate orientation of a vehicle window when the flag support block 10 is in the horizontal orientation, this is a suggested angle only and those skilled in the art will recognize a wide range of angles will produce a suitable display angle for the flag 16 when mounted to the flag support block 10. Additionally, while it is desirable that the thickness of the lip member 14 approximate that of a vehicle window, any thickness that can be accepted within the U-shaped mounting member will suffice provided that it is sufficiently strong to support the flag 16 in the desired orientation.

While the invention has been described with respect to preferred embodiments, it is not to be so limited since changes and variations may be made therein which do not depart from the broad spirit and scope of the invention as defined in the appended claims.

I claim:

1. A flag support block for mounting and display of a flag having a U-shaped mounting member intended for mounting on a vehicle window, comprising:
(a) a base member; and
(b) a lip member projected from said base member, wherein the U-shaped mounting member of the flag is supported by the lip member in an orientation suitable for display of the flag.

2. A flag support block as defined in claim 1, wherein the base member is supported on a horizontal surface and the lip member supports the mounting member of the flag in a first orientation to display the flag at a suitable angle.

3. A flag support block as defined in claim 1, wherein the base member is supported on a vertical surface, and the lip member supports the mounting member of the flag in a second orientation to display the flag at a suitable angle.
